(19) United States
(12) Patent Application Publication
(10) Pub. No.: US 2026/0302926 A1
(43) Pub. Date: Oct. 1, 2026

(54) BIDIRECTIONAL POWER SUPPLY DEVICE

(71) Applicant: KABUSHIKI KAISHA TOYOTA JIDOSHOKKI, Aichi (JP)

(72) Inventor: Naohiro NOMURA, Aichi-ken (JP)

(73) Assignee: KABUSHIKI KAISHA TOYOTA JIDOSHOKKI, Aichi (JP)

(21) Appl. No.: 19/578,043

(22) Filed: Mar. 25, 2026

(30) Foreign Application Priority Data
Mar. 28, 2025 (JP) 2025-054735

(51) Int. Cl. H02M 1/088; H02M 1/00; H02M 1/42; H02M 7/797

(52) U.S. Cl. CPC H02M 1/088; H02M 1/0012; H02M 1/4233; H02M 7/797

(57) ABSTRACT

A drive signal for a switching element is generated using an arithmetic current waveform having a larger absolute value than an absolute value of a target current waveform in a first mode in which an AC power supply is connected to one end of a power supply circuit and a DC load is connected to the other end, and a drive signal for the switching element is generated using an arithmetic current waveform having a smaller absolute value than the absolute value of the target current waveform in a second mode in which an AC load is connected to the one end of the power supply circuit and a DC power supply is connected to the other end of the power supply circuit.

### CROSS-REFERENCE TO RELATED APPLICATION

This application is based upon and claims the benefit of priority to Japanese Patent Application No. 2025-054735, Filed on Mar. 28, 2025, the entire contents of which are incorporated herein by reference.

### FIELD

The present invention relates to a bidirectional power supply device.

### BACKGROUND

As a bidirectional power supply device, there is a bidirectional power supply device including a totem pole type PFC circuit including a coil and four switching elements connected in an H-bridge connection, and a control unit. The control unit controls operations of the switching elements so that an AC power is converted into a DC power in a first mode in which an AC power supply is connected to one end of the PFC circuit and a DC load is connected to the other end, and controls operations of the switching elements so that the DC power is converted into the AC power in a second mode in which an AC load is connected to the one end of the PFC circuit and a DC power supply is connected to the other end. In addition, in the first mode and the second mode, the control unit controls operations of two switching elements in one arm of the PFC circuit in accordance with the polarity of the alternating current, and controls operations of switching elements in the other arm such that the current flowing through the coil becomes a target current. JP 2019-161830 A discloses a related technique.

Meanwhile, peak current control has been proposed as one of control methods for controlling operations of switching elements. In this control method, an on-period of the switching elements is controlled by comparing a threshold signal waveform based on a target current and a ramp signal with a coil current.

Here, the switching element in the other arm that has a period until the coil current matches the threshold signal waveform as an ON period and a period after the ON period as an OFF period, for example, is focused as a control target switching element. In a case where the polarity of the alternating current is in a positive period, it is necessary to control the lower switching element in the other arm as the control target switching element in order to cause the PFC circuit to perform a boosting operation in the first mode and to control the upper switching element in the other arm as the control target switching element in order to cause the PFC circuit to perform a buck operation in the second mode.

In other words, since it is necessary to switch the control target switching element at the time of switching between the first mode and the second mode in a case where the peak current control is performed using the same threshold signal waveform for each of the first mode and the second mode in the bidirectional power supply device, and it is necessary to add hardware such as a selector for the switching, there is a concern about an increase in manufacturing cost.

### SUMMARY OF THE INVENTION

An object of one aspect of the present invention is to provide a bidirectional power supply device capable of eliminating a need for hardware for switching a control target switching element at the time of switching between a first mode and a second mode.

A bidirectional power supply device according to one aspect of the present invention includes: a power supply circuit including a coil and a switching element connected in an H bridge connection by a plurality of arms; and a control unit that controls operations of an upper arm switching element and a lower arm switching element in one arm of the power supply circuit in accordance with a polarity of an alternating current at one end and controls operations of the upper arm switching element and the lower arm switching element in the other arm of the power supply circuit so that a coil current flowing through the coil becomes a target current in a first mode in which an AC power supply is connected to one end of the power supply circuit and a DC load is connected to the other end of the power supply circuit or a second mode in which an AC load is connected to the one end of the power supply circuit and a DC power supply is connected to the other end of the power supply circuit.

The control unit is configured such that, as the other arm drive signal for driving the upper arm switching element and the lower arm switching element in the other arm, the control unit compares a first threshold signal waveform obtained by adding a ramp signal in a direction approaching zero to an arithmetic current value in an initial stage of each control cycle of the switching elements with the coil current using an arithmetic current waveform having a larger absolute value than an absolute value of a target current waveform and generates the other arm drive signal that switches between a period until the coil current matches the first threshold signal waveform from the initial stage of the control cycle and a period until the initial stage of the next control cycle after the coil current matches the first threshold signal waveform, in one of the first mode and the second mode.

Also, the control unit compares a second threshold signal waveform obtained by adding the ramp signal in a direction separated from zero to the arithmetic current value in the initial stage of each control cycle with the coil current using an arithmetic current waveform having a smaller absolute value than the absolute value of the target current waveform and generates the other arm drive signal that switches between a period until the coil current matches the second threshold signal waveform from the initial stage of the control cycle and a period until the initial stage of the next control cycle after the coil current matches the second threshold signal waveform, in the other one of the first mode and the second mode.

In this manner, there is no need to switch the control target switching element at the time of switching between the first mode and the second mode, and it is thus possible to eliminate the need for hardware for the switching.

Also, the control unit may be configured such that the control unit generates a first signal having a period until the coil current matches the first threshold signal waveform from the initial stage of the control cycle as an ON period and having a period until the initial stage of the next control cycle after the coil current matches the first threshold signal waveform as an OFF period in the first mode, the control unit generates a second signal having a period until the coil current matches the second threshold signal waveform from the initial stage of the control cycle as an ON period and having a period until the initial stage of the next control cycle after the coil current matches the second threshold signal waveform as an OFF period in the second mode, the control unit uses the first signal and the second signal as drive signals for the one switching elements in the other arm and uses inverted signals of the first signal and the second signal as drive signals for the other switching element in the other arm in a positive period of a polarity of the alternating current, and the control unit uses the first signal and the second signal as drive signals for the other switching element in the other arm and uses the inverted signals of the first signal and the second signal as drive signals for the one switching element in the other arm in a negative period of the polarity of the alternating current.

Moreover, the control unit may be configured such that when Imag denotes an amplitude of the target current waveform, @ denotes an angular frequency of the target current waveform, t denotes a current clock time, Vdc is a DC voltage output from the power supply circuit or a DC voltage input to the power supply circuit, VAC denotes an instantaneous value of an AC voltage input to the power supply circuit or an AC voltage output from the power supply circuit, L denotes an inductance value of the coil, SA denotes an amplitude of the ramp signal, and Ts denotes the control cycle, the control unit regards Itgt1(n), which is a calculation result of Expression 1 below, as the arithmetic current value to be used in the first mode and regards Itgt2(n), which is a calculation result of Expression 2 below, as the arithmetic current value to be used in the second mode.

$$Itgt 1 ( n ) = Imag \cdot sin ω t + \frac{VAC}{2 L} ( 1 - \frac{VAC}{VH} ) \cdot Ts + SA \cdot ( 1 - \frac{VAC}{VH} ) \qquad Expression 1$$

$$Itgt 2 ( n ) = Imag \cdot sin ω t + \frac{( VH - VAC )}{2 L} \cdot \frac{VAC}{VH} \cdot Ts + SA \cdot \frac{VAC}{VH} \qquad Expression 2$$

According to the present invention, it is possible to eliminate a need for hardware for switching a control target switching element at the time of switching between a first mode and a second mode in a bidirectional power supply device.

### BRIEF DESCRIPTION OF THE DRAWINGS

FIG. 1 is a diagram illustrating an example of a bidirectional power supply device according to an embodiment;

FIGS. 2A to 2C are diagrams illustrating an example of a coil current, an arithmetic current waveform, a target current waveform, and a first threshold signal waveform in a first mode;

FIGS. 3A to 3C are diagrams illustrating an example of a coil current, an arithmetic current waveform, a target current waveform, and a second threshold signal waveform in a second mode; and

FIGS. 4A and 4B are diagrams illustrating an example of a peak current control circuit and a truth value table.

### DESCRIPTION OF EMBODIMENTS

An embodiment will be described below in detail on the basis of the drawings.

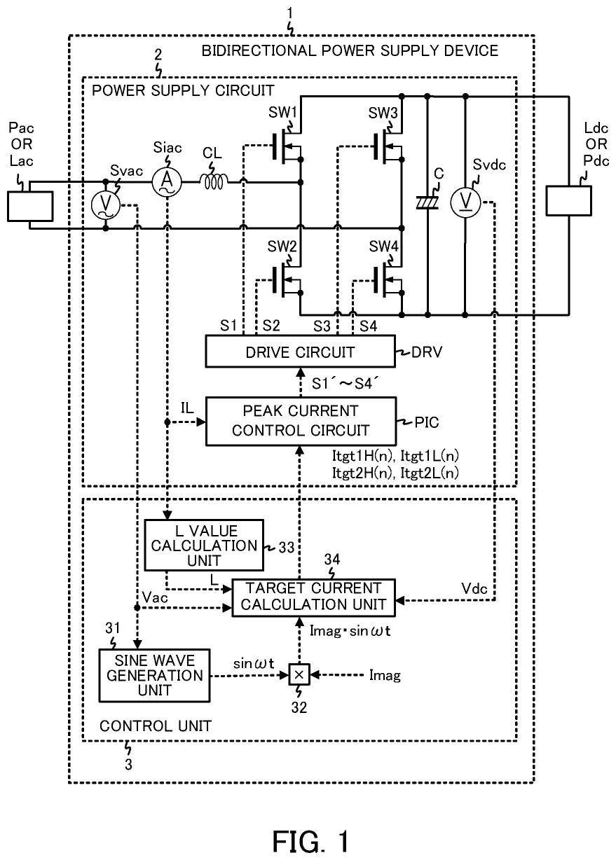

FIG. 1 is a diagram illustrating an example of a bidirectional power supply device according to the embodiment.

In the following description, an “increase” of a coil current IL indicates an increase in the absolute value thereof, and a “decrease” thereof indicates a decrease in the absolute value thereof, that is, approaching to zero.

A bidirectional power supply device 1 illustrated in FIG. 1 includes a power supply circuit 2 and a control unit 3 that controls operations of the power supply circuit 2, and has a first mode in which an AC power supply Pac is connected to one end of the power supply circuit 2 and a DC load Ldc is connected to the other end of the power supply circuit 2, and a second mode in which an AC load Lac is connected to the one end of the power supply circuit 2 and a DC power supply Pdc is connected to the other end of the power supply circuit 2. For example, the bidirectional power supply device 1 is mounted on a vehicle such as an electric vehicle or an industrial vehicle. In addition, the AC power supply Pac is a system power supply, the DC load Ldc is a secondary battery such as a lithium ion battery or a home appliance driven by a DC power, the DC power supply Pdc is a secondary battery such as a lithium ion battery, and the AC load Lac is a home appliance driven by an AC power such as a personal computer. In a case where the DC load Ldc is a secondary battery, the first mode corresponds to a charging period, and the second mode corresponds to a power supply period. In addition, the control unit 3 has a function of switching between the first mode and the second mode on the basis of an instruction from a user or the like, and can determine which mode the current mode is.

### Configuration Example (1) of Power Supply Circuit 2

The power supply circuit 2 is a totem pole type power factor correction (PFC) circuit, and includes a coil CL, four switching elements SW1 to SW4 connected in an H bridge connection, and a capacitor C. Note that the switching elements SW1 to SW4 are, for example, metal oxide semiconductor field effect transistors (MOSFETs). In a case where the switching elements SW1 to SW4 are not distinguished from each other, the switching elements SW1 to SW4 will be simply referred to as switching elements SW.

### <Connection Example of Coil CL, Switching Elements SW1 to SW4, and Capacitor C>

One terminal of the coil CL is connected to one terminal of the AC power supply Pac or the AC load Lac, and a connection point between a source terminal of the switching element SW3 and a drain terminal of the switching element SW4 is connected to the other terminal of the AC power supply Pac or the AC load Lac. The other terminal of the coil CL is connected to a connection point between a source terminal of the switching element SW1 and a drain terminal of the switching element SW2. Drain terminals of the switching elements SW1 and SW3 are connected to each other, and are connected to one terminal of the capacitor C and one terminal of the DC load Ldc or the DC power supply Pdc. Source terminals of the switching elements SW2 and SW4 are connected to each other, and are connected to the other terminal of the capacitor C and the other terminal of the DC load Ldc or the DC power supply Pdc.

### <Operation Example of Switching Elements SW1 to SW4 in First Mode>

In the first mode and in a positive period of the AC power input to the power supply circuit 2 (a period during which a current flows from AC power supply Pac to the switching elements SW1 and SW2 via the coil CL (in the first mode, a coil current IL flowing in this direction is regarded as being positive)), the switching element SW3 in one arm of the power supply circuit 2 is turned off, while the switching element SW4 in the one arm is turned on. At this time, the switching element SW2 as a control target switching element in the other arm of the power supply circuit 2 is turned on and off such that a coil current IL flowing through the coil CL becomes a target current. Note that the switching element SW1 is turned off when the switching element SW2 is turned on and the switching element SW1 is turned on when the switching element SW2 is turned off. Moreover, the coil current IL increases when the switching element SW2 is turned on, and the coil current IL decreases when the switching element SW1 is turned on. In other words, in the first mode and in the positive period of the AC power input to the power supply circuit 2, the coil current IL “increases” when the switching element SW2 is turned on, and the coil current IL “decreases” when the switching element SW2 is turned off.

In the first mode and in a negative period of the AC power input to the power supply circuit 2 (a period during which a current flows from switching elements SW1 and SW2 to the AC power supply Pac via the coil CL), the switching element SW3 in the one arm of the power supply circuit 2 is turned on, and the switching element SW4 in the one arm is turned off. At this time, the switching element SW1 as a control target in the other arm of the power supply circuit 2 is turned on and off such that a coil current IL becomes the target current. Note that the switching element SW2 is turned off when the switching element SW1 is turned on and the switching element SW2 is turned on when the switching element SW1 is turned off. Moreover, the coil current IL increases when the switching element SW1 is turned on, and the coil current IL decreases when the switching element SW2 is turned on. In other words, in the first mode and in the negative period of the AC power input to the power supply circuit 2, the coil current IL “decreases” when the switching element SW2 is turned on, and the coil current IL “increases” when the switching element SW2 is turned off.

The AC power input from the AC power supply Pac to the power supply circuit 2 is rectified, and the rectified power is smoothed by the capacitor C and is then output as a DC power to the DC load Ldc by the switching elements SW1 to SW4 being turned on and off in the first mode in this manner.

Note that the power factor at the time of conversion from the AC power to the DC power approaches 1, and the power factor of the power supply circuit 2 can be improved by the target current being set such that the waveform of the coil current IL becomes a sine wave and a phase difference between the coil current IL and the AC voltage approaches zero.

### <Operation Example of Switching Elements SW1 to SW4 in Second Mode>

In the second mode and in a positive period of the AC power output from the power supply circuit 2 (a period during which a current flows from switching elements SW1 and SW2 to the AC load Lac via the coil CL (in the second mode, the coil current IL flowing in this direction is regarded as being positive)), the switching element SW3 in the one arm of the power supply circuit 2 is turned off, and the switching element SW4 in the one arm is turned on. At this time, the switching element SW2 as a control target switching element in the other arm of the power supply circuit 2 is turned on and off such that a coil current IL becomes a target current. Note that the switching element SW1 is turned off when the switching element SW2 is turned on and the switching element SW1 is turned on when the switching element SW2 is turned off. Moreover, the coil current IL increases when the switching element SW1 is turned on, and the coil current IL decreases when the switching element SW2 is turned on. In other words, in the second mode and in the positive period of the AC power output from the power supply circuit 2, the current flowing from the coil CL to the AC load Lac “decreases” when the switching element SW2 is turned on, and the current flowing from the coil CL to the AC load Lac “increases” when the switching element SW2 is turned off.

In the second mode and in the negative period of the AC power output from the power supply circuit 2 (the period during which a current flows from the AC load Lac to the switching elements SW1 and SW2 via the coil CL), the switching element SW3 in the one arm of the power supply circuit 2 is turned on, and the switching element SW4 in the one arm is turned off. At this time, the switching element SW1 as a control target switching element in the other arm of the power supply circuit 2 is turned on and off such that a coil current IL becomes a target current. Note that the switching element SW2 is turned off when the switching element SW1 is turned on and the switching element SW2 is turned on when the switching element SW1 is turned off. Moreover, the coil current IL increases when the switching element SW2 is turned on, and the coil current IL decreases when the switching element SW1 is turned on. In other words, in the second mode and in the negative period of the AC power output from the power supply circuit 2, the coil current IL “increases” when the switching element SW2 is turned on, and the coil current IL “decreases” when the switching element SW2 is turned off.

The DC power input from the DC power supply Pdc to the power supply circuit 2 is converted into the AC power and is then output to the AC load Lac by the switching elements SW1 to SW4 being turned on and off in the second mode in this manner.

### <Configuration Example (2) of Power Supply Circuit 2>

The power supply circuit 2 includes a voltage detection unit Svac, a current detection unit Siac, a voltage detection unit Svdc, a peak current control circuit PIC, and a drive circuit DRV. Note that the peak current control circuit PIC may be configured to be included in the control unit 3.

The voltage detection unit Svac is configured by an AC voltmeter or the like, detects the AC voltage Vac input from the AC power supply Pac to the power supply circuit 2 in the first mode or the AC voltage Vac output from the power supply circuit 2 to the AC load Lac in the second mode, and sends the detected AC voltage Vac to the control unit 3. Note that it is assumed that the AC voltage Vac detected by the voltage detection unit Svac is converted from an analog value to a digital value and is then input to the control unit 3.

The current detection unit Siac is configured by an AC ammeter or the like, detects the coil current IL flowing through the coil CL in the first mode or the coil current IL flowing through the coil CL in the second mode, and sends the detected coil current IL to the control unit 3. Note that it is assumed that the coil current IL detected by the current detection unit Siac is converted from an analog value to a digital value and is then input to the control unit 3.

The voltage detection unit Svdc is configured by a DC voltmeter or the like, detects the DC voltage Vdc output from the power supply circuit 2 to the DC load Ldc in the first mode or the DC voltage Vdc input from the DC power supply Pdc to the power supply circuit 2 in the second mode, and sends the detected DC voltage Vdc to the control unit 3. Note that it is assumed that the DC voltage Vdc detected by the voltage detection unit Svdc is converted from an analog value to a digital value and is then input to the control unit 3.

The peak current control circuit PIC is configured by an integrated circuit (IC) or the like. In addition, the peak current control circuit PIC outputs drive signals S1′ to S4′ on the basis of a result of comparing a threshold signal waveform obtained from an arithmetic current value Itgt1H(n) or an arithmetic current value Itgt1L(n) sent from the control unit 3 and a predetermined ramp signal with the coil current IL detected by the current detection unit Siac in the first mode. In addition, the peak current control circuit PIC outputs drive signals S1′ to S4′ on the basis of a result of comparing a threshold signal waveform obtained from an arithmetic current value Itgt2L(n) or an arithmetic current value Itgt2H(n) sent from the control unit 3 and a predetermined ramp signal with the coil current IL detected by the current detection unit Siac in the second mode. Note that the ramp signal is generated by the peak current control circuit PIC by the voltage value generated by supplying a constant current to the capacitor being reset at a predetermined control cycle Ts, and the amplitude thereof is SA, which will be described later.

The drive circuit DRV is configured by an IC or the like, generates drive signals S1 to S4 for causing the switching elements SW1 to SW4 to operate on the basis of the drive signals S1′ to S4′ output from the peak current control circuit PIC and outputs the drive signals S1 to S4 to gate terminals of the switching elements SW1 to SW4.

### <Concerning Peak Current Control in First Mode>

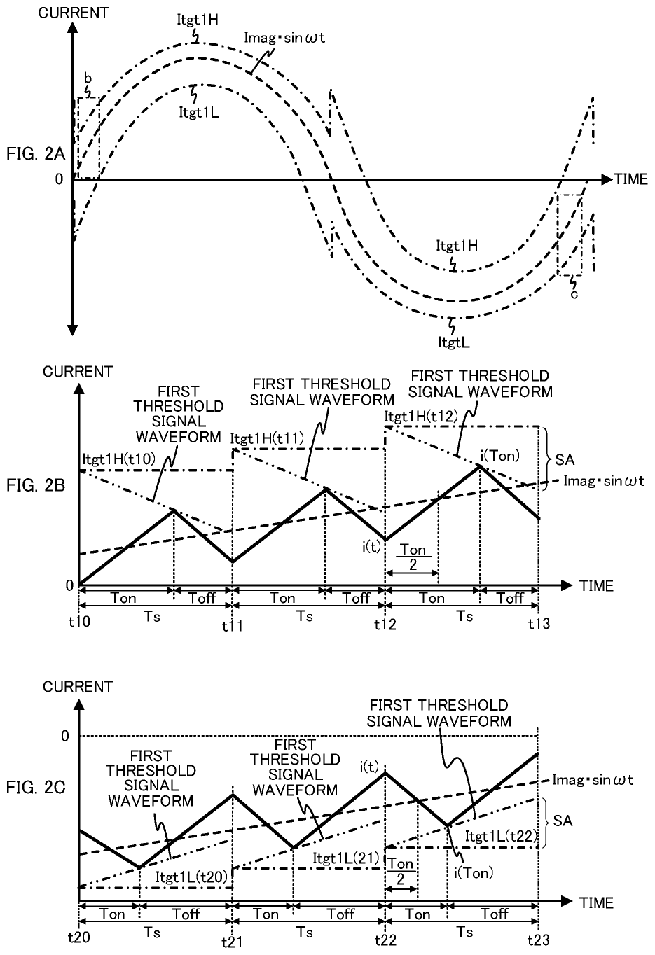

FIG. 2A is a diagram schematically illustrating a target current waveform Imag·sinωt, an arithmetic current waveform Itgt1H, and an arithmetic current waveform Itgt1L in one cycle in the first mode. FIG. 2B is a diagram illustrating the coil current IL, the target current waveform Imag·sinωt, the arithmetic current value Itgt1H(n), and a first threshold signal waveform in each control cycle Ts of the switching element SW2 in the section indicated by the one-dotted chain line b in FIG. 2A, in the first mode, and in the positive period of the AC power input to the power supply circuit 2. FIG. 2C is a diagram illustrating the coil current IL, the target current waveform Imag·sinωt, the arithmetic current value Itgt1L(n), and a first threshold signal waveform in each control cycle Ts of the switching element SW1 in the section indicated by the one-dotted chain line c in FIG. 2A, in the first mode, and in the negative period of the AC power input to the power supply circuit 2. Note that the horizontal axis of the two-dimensional coordinates illustrated in FIGS. 2A to 2C represents a time, and the vertical axis represents a current. Furthermore, the solid line illustrated in FIGS. 2A to 2C represents the coil current IL, the dashed line indicates the target current waveform Imag·sinωt, the one-dotted chain line represents an arithmetic current value Itgt1H(n) and the arithmetic current value Itgt1L(n), the two-dotted chain line represents the first threshold signal waveform, and SA represents the amplitude of the ramp signal. In addition, slope compensation may be considered for the ramp signal.

As illustrated in FIGS. 2A and 2B, the control unit 3 calculates the arithmetic current value Itgt1H(n) which is an initial (t10, t11, t12) value of each control cycle Ts of the arithmetic current waveform Itgt1H having a larger absolute value than the absolute value of the target current waveform Imag·sinωt in the first mode and in the positive period of the AC power input to the power supply circuit 2. Furthermore, in the first mode and in the positive period of the AC power input to the power supply circuit 2, the peak current control circuit PIC compares a first threshold signal waveform obtained by adding a ramp signal in the direction approaching zero to the arithmetic current value Itgt1H(n) calculated by the control unit 3 with the coil current IL, regards a period Ton until the coil current IL matches the first threshold signal waveform from the initial stage of the control cycle Ts as a period (ON period) during which the switching element SW2 is turned on, regards a period Toff until the initial stage of the next control cycle Ts after the coil current IL matches the first threshold signal waveform as a period (OFF period) during which the switching element SW2 is turned off, and generates a signal including the periods Ton and Toff as a drive signal S2′ (first signal), and an inverted signal of the drive signal S2′ is generated as a drive signal S1′. Note that in the first mode and in the positive period of the AC power input to the power supply circuit 2, the control unit 3 prevents the first threshold signal waveform based on the arithmetic current value Itgt1L(n) from being compared with the coil current IL in the peak current control circuit PIC by performing calculation such that the arithmetic current value Itgt1L(n) is shifted on the negative side as illustrated in FIG. 2A.

As illustrated in FIGS. 2A and 2C, in the first mode and in the negative period of the AC power input to the power supply circuit 2, the control unit 3 calculates the arithmetic current value Itgt1L(n) which is an initial (t20, t21, t22) value of each control cycle Ts of the arithmetic current waveform Itgt1L having a larger absolute value than the absolute value of the target current waveform Imag·sinωt. Furthermore, in the first mode and in the negative period of the AC power input to the power supply circuit 2, the peak current control circuit PIC compares a first threshold signal waveform obtained by adding a ramp signal in the direction approaching zero to the arithmetic current value Itgt1L(n) calculated by the control unit 3 with the coil current IL, regards a period Ton until the coil current IL matches the first threshold signal waveform from the initial stage of the control cycle Ts as a period (ON period) during which the switching element SW1 is turned on, regards a period Toff until the initial stage of the next control cycle Ts after the coil current IL matches the first threshold signal waveform as a period (OFF period) during which the switching element SW1 is turned off, and generates a signal including the periods Ton and Toff as a drive signal S1′ (first signal), and an inverted signal of the drive signal S1′ as a drive signal S2′. Note that in the first mode and in the negative period of the AC power input to the power supply circuit 2, the control unit 3 prevents the first threshold signal waveform based on the arithmetic current value Itgt1H(n) from being compared with the coil current IL in the peak current control circuit PIC by performing calculation such that the arithmetic current value Itgt1H(n) is shifted on the positive side as illustrated in FIG. 2A. Note that the drive signals S1′ and S2′ correspond to the other arm drive signals of the present invention.

In other words, in the first mode and in the positive period of the AC power input to the power supply circuit 2, the coil current IL is “increased” by turning on the switching element SW2 in the period Ton of the drive signal S2′, and the coil current IL is “decreased” by turning off the switching element SW2 in the period Toff of the drive signal S2′. Also, in the first mode and in the negative period of the AC power input to the power supply circuit 2, the coil current IL is “increased” by turning on the switching element SW1 (turning off the switching element SW2) in the period Ton of the drive signal S1′, and the coil current IL is “decreased” by turning off the switching element SW1 (turning on the switching element SW2) in the period Toff of the drive signal S1′.

### <Concerning Peak Current Control in Second Mode>

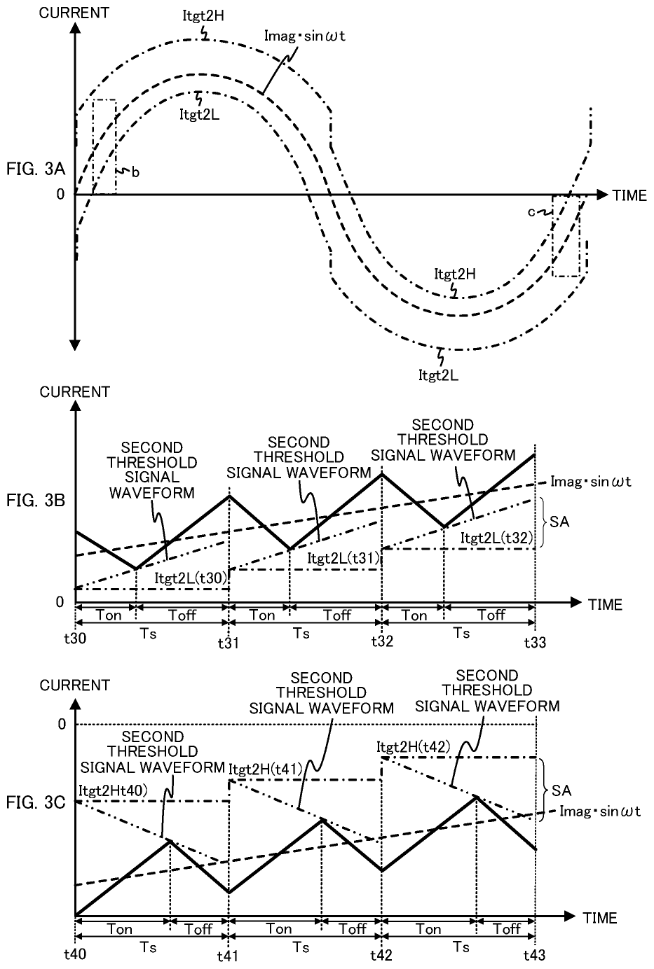

FIG. 3A is a diagram schematically illustrating a target current waveform Imag·sinωt, an arithmetic current waveform Itgt2H, and an arithmetic current waveform Itgt2L in one cycle in the second mode. FIG. 3B is a diagram illustrating an example of the coil current IL, the target current waveform Imag·sinωt, the arithmetic current value Itgt2L(n), and a second threshold signal waveform in each control cycle Ts of the switching element SW2 in the section indicated by the one-dotted chain line b in FIG. 3A, in the second mode, and in the positive period of the AC power output from the power supply circuit 2. FIG. 3C is a diagram illustrating an example of the coil current IL, the target current waveform Imag·sinωt, the arithmetic current value Itgt2H(n), and the second threshold signal waveform in each control cycle Ts of the switching element SW1 in the section indicated by the one-dotted chain line c in FIG. 3A, in the second mode, and in the negative period of the AC power output from the power supply circuit 2. Note that the horizontal axis of the two-dimensional coordinates illustrated in FIGS. 3A to 3C represents a time, and the vertical axis represents a current. Furthermore, the solid line illustrated in FIGS. 3A to 3C represents the coil current IL, the dashed line indicates the target current waveform Imag·sinωt, the one-dotted chain line represents an arithmetic current value Itgt2H and the arithmetic current value Itgt2L, the two-dotted chain line represents the second threshold signal waveform, and SA represents the amplitude of the ramp signal.

As illustrated in FIGS. 3A and 3B, in the second mode and in the positive period of the AC power output from the power supply circuit 2, the control unit 3 calculates the arithmetic current value Itgt2L(n) which is an initial (t30, t31, t32) value of each control cycle Ts of the arithmetic current waveform Itgt2L having a smaller absolute value than the absolute value of the target current waveform Imag·sinωt. Furthermore, in the second mode and in the positive period of the AC power output from the power supply circuit 2, the peak current control circuit PIC compares a second threshold signal waveform obtained by adding a ramp signal in the direction separated from zero to the arithmetic current value Itgt2L(n) with the coil current IL, regards a period Ton until the coil current IL matches the second threshold signal waveform from the initial stage of the control cycle Ts as a period (ON period) during which the switching element SW2 is turned on, regards a period Toff until the initial stage of the next control cycle Ts after the coil current IL matches the second threshold signal waveform as a period (OFF period) during which the switching element SW2 is turned off, and generates a signal including the periods Ton and Toff as a drive signal S2′ (second signal), and an inverted signal of the drive signal S2′ as a drive signal S1′. Note that in the second mode and in the positive period of the AC power output from the power supply circuit 2, the control unit 3 prevents the second threshold signal waveform based on the arithmetic current value Itgt2H(n) from being compared with the coil current IL in the peak current control circuit PIC by performing calculation such that the arithmetic current value Itgt2H(n) is shifted on the positive side as illustrated in FIG. 3A.

As illustrated in FIGS. 3A and 3B, in the second mode and in the negative period of the AC power input to the power supply circuit 2, the control unit 3 calculates the arithmetic current value Itgt2H(n) which is an initial (t40, t41, t42) value of each control cycle Ts of the arithmetic current waveform Itgt2H having a smaller absolute value than the absolute value of the target current waveform Imag·sinωt. Furthermore, in the second mode and in the negative period of the AC power input to the power supply circuit 2, the peak current control circuit PIC compares a second threshold signal waveform obtained by adding a ramp signal in the direction separated from zero to the arithmetic current value Itgt2H(n) with the coil current IL, regards a period Ton until the coil current IL matches the second threshold signal waveform from the initial stage of the control cycle Ts as a period (ON period) during which the switching element SW1 is turned on (the switching element SW2 is turned off), regards a period Toff until the initial stage of the next control cycle Ts after the coil current IL matches the second threshold signal waveform as a period (OFF period) during which the switching element SW1 is turned off (the switching element SW2 is turned on), and generates a signal including the periods Ton and Toff as a drive signal S1′ (second signal), and an inverted signal of the drive signal S1′ as a drive signal S2′. Note that in the second mode and in the negative period of the AC power output from the power supply circuit 2, the control unit 3 prevents the second threshold signal waveform based on the arithmetic current value Itgt2L(n) from being compared with the coil current IL in the peak current control circuit PIC by performing calculation such that the arithmetic current value Itgt2L(n) is shifted on the negative side as illustrated in FIG. 3A. Note that the drive signals S1′ and S2′ correspond to the other arm drive signals of the present invention.

In other words, in the second mode and in the positive period of the AC power output from the power supply circuit 2, the coil current IL is “decreased” by turning on the switching element SW2 in the period Ton of the drive signal S2′, and the coil current IL is “increased” by turning off the switching element SW2 in the period Toff of the drive signal S2′. Also, in the second mode and in the negative period of the AC power output from the power supply circuit 2, the coil current IL is “decreased” by turning on the switching element SW1 (turning off the switching element SW2) in the period Ton of the drive signal S1′, and the coil current IL is “increased” by turning off the switching element SW1 (turning on the switching element SW2) in the period Toff of the drive signal S1′.

### <Concerning Actions and Effects of Embodiment>

In this manner, in the first mode and in the positive period of the AC power input to the power supply circuit 2, the first threshold signal waveform based on the arithmetic current value Itgt1H(n) is compared with the coil current IL to thereby obtain the periods Ton and Toff (the other arm drive signals) of the drive signal S2′. It is thus possible to “increase” the coil current IL when the switching element SW2 is turned on and to “decrease” the coil current IL when the switching element SW2 is turned off in the first mode and in the positive period of the AC power input to the power supply circuit 2.

Also, in the first mode and in the negative period of the AC power input to the power supply circuit 2, the first threshold signal waveform based on the arithmetic current value Itgt1L(n) is compared with the coil current IL to thereby obtain the periods Ton and Toff (the other arm drive signals) of the drive signal S1′. It is thus possible to “decrease” the coil current IL when the switching element SW2 is turned on and to “increase” the coil current IL when the switching element SW2 is turned off in the first mode and in the negative period of the AC power input to the power supply circuit 2.

In other words, in the first mode, the first threshold signal waveform obtained by adding the ramp signal in the direction approaching zero to the initial arithmetic current value (Itgt1H(n) or Itgt1L(n)) of the arithmetic current waveform (Itgt1H or Itgt1L) having a larger absolute value than the absolute value of the target current waveform Imag·sinωt is compared with the coil current IL to thereby generate the other arm drive signal.

Also, in the second mode and in the positive period of the AC power output from the power supply circuit 2, the second threshold signal waveform based on the arithmetic current value Itgt2L(n) is compared with the coil current IL to thereby obtain the periods Ton and Toff (the other arm drive signals) of the drive signal S2′. It is thus possible to “decrease” the coil current IL when the switching element SW2 is turned on and to “increase” the coil current IL when the switching element SW2 is turned off in the second mode and in the positive period of the AC power output from the power supply circuit 2.

Also, in the second mode and in the negative period of the AC power output from the power supply circuit 2, the threshold signal waveform based on the arithmetic current value Itgt2H(n) instead of the arithmetic current value Itgt2L(n) is compared with the coil current IL to thereby obtain the periods Ton and Toff (the other arm drive signals) of the drive signal S1′. It is thus possible to “increase” the coil current IL when the switching element SW2 is turned on and to “decrease” the coil current IL when the switching element SW2 is turned off in the second mode and in the negative period of the AC power output from the power supply circuit 2.

In other words, in the second mode, the second threshold signal waveform obtained by adding the ramp signal in the direction separated from zero to the initial arithmetic current value (Itgt2H(n) or Itgt2L(n)) of the arithmetic current waveform (Itgt2H or Itgt2L) having a smaller absolute value than the absolute value of the target current waveform Imag·sinωt is compared with the coil current IL to thereby generate the other arm drive signal.

In this manner, the bidirectional power supply device 1 of the embodiment generates the threshold signal waveforms to be compared with the coil current IL in the first mode and the second mode by switching between the arithmetic current waveform having a larger absolute value than the absolute value of the target current waveform Imag·sinωt and the arithmetic current waveform having a smaller absolute value than the absolute value of the target current waveform Imag·sinωt. Therefore, since the control target switching elements to be caused to follow the target currents are the same in the first mode and the second mode, there is no need to switch the control target switching element at the time of the switching between the first mode and the second mode, and it is thus possible to eliminate the need for hardware for selecting the control target switching element.

In a case where either the arithmetic current waveform having a larger absolute value than the absolute value of the target current waveform Imag·sinωt or the arithmetic current waveform having a smaller absolute value than the absolute value of the target current waveform Imag·sinωt is fixed for the threshold signal waveform to be compared with the coil current IL in the first mode and the second mode, there is a need to perform switching between the switching element SW1 and the switching element SW2 as the control target switching element in the first mode and the second mode, and there is thus a need for hardware to select the control target switching element.

Note that since it is necessary to switch the arithmetic current value to be used for generating the threshold signal waveform at the time of switching between the positive period and the negative period, that is, when the AC polarity is changed, all the switching elements may be forcibly turned off for a predetermined period of time.

### <Configuration Example of Control Unit 3>

The control unit 3 illustrated in FIG. 1 includes a sine wave generation unit 31, a multiplication unit 32, an L value calculation unit 33, and a target current calculation unit 34. Note that the control unit 3 is configured by, for example, a central processing unit (CPU), a multicore CPU, or a programmable device (such as a field programmable gate array (FPGA) or a programmable logic device (PLD)).

The sine wave generation unit 31 generates a sine wave sinωt on the basis of an angular frequency ω of an AC voltage Vac. Note that t is the current time and the angular frequency ω is the frequency ×2π of the AC voltage Vac.

The multiplication unit 32 multiplies the amplitude value Imag of the target current waveform by the sine wave sinωt and outputs a target current waveform Imag·sinωt (ideal sine wave) which is the multiplication result. Note that the amplitude value Imag of the target current waveform may be obtained on the basis of a DC voltage Vdc.

The L value calculation unit 33 calculates an inductance value L of the coil CL by the coil current IL.

The target current calculation unit 34 calculates the arithmetic current values Itgt1H(n) and Itgt1L(n) in the first mode and calculates the arithmetic current values Itgt2L(n) and Itgt2H(n) in the second mode on the basis of the AC voltage Vac, the coil current IL, the DC voltage Vdc, the amplitude SA of the ramp signal, and the target current waveform Imag·sinωt.

### <Calculation Example of Arithmetic Current Values Itgt1H(n) and Itgt1L(n)>

For example, the target current calculation unit 34 sets an instantaneous value VAC of the AC voltage Vac, the target current waveform Imag·sinωt, and the inductance value L. It is assumed that the average value of the coil current IL matches the target current waveform Imag·sinωt, that is, the average value of the coil current IL that changes in the ON period Ton of the control cycle Ts matches the target current waveform Imag·sinωt when half of the ON period Ton has elapsed from the initial clock time of the ON period Ton. In addition, the amount of change in coil current IL that changes in the ON period Ton can be expressed by the instantaneous value VAC, the inductance value L, and the ON period Ton. In addition, since the coil current IL matches the threshold signal waveform at the end of the ON period Ton, the coil current IL at the end of the ON period Ton can be expressed using the arithmetic current value Itgt1H(n) (or Itgt1L(n)), the amplitude SA of the ramp signal, the ON period Ton, and the control cycle Ts. In addition, the ON period Ton can be expressed by a ratio between the instantaneous value VAC and the DC voltage Vdc. Using the above conditions, the calculation result of Expression 1 below is obtained as the arithmetic current value Itgt1H(n) or the arithmetic current value Itgt1L(n). Note that it is assumed that the arithmetic current value Itgt1H(n) is obtained by the target current waveform Imag·sinωt and the instantaneous value VAC becoming positive values in a case where the AC power input to the power supply circuit 2 is in the positive period and that the arithmetic current value Itgt1L(n) is obtained by the target current waveform Imag·sinωt and the instantaneous value VAC becoming negative values in a case where the AC power input to the power supply circuit 2 is in the negative period. In addition, it is assumed that the amplitude SA and the control cycle Ts are stored in the target current calculation unit 34 in advance. In a case where the amount of variation in inductance value L does not affect the calculation of the arithmetic current values Itgt1H(n) and Itgt1L(n), the inductance value L may be stored as a constant in the target current calculation unit 34 in advance. In this case, the L value calculation unit 33 may be omitted.

$$Itgt 1 ( n ) = Imag \cdot sin ω t + \frac{VAC}{2 L} ( 1 - \frac{VAC}{VH} ) \cdot Ts + SA \cdot ( 1 - \frac{VAC}{VH} ) \qquad Expression 1$$

### <Calculation Example of Arithmetic Current Values Itgt2L(n) and Itgt2H(n)>

For example, the target current calculation unit 34 sets an instantaneous value VAC of the AC voltage Vac, the target current waveform Imag·sinωt, and the inductance value L. Using conditions similar to those in the calculation example of the arithmetic current values Itgt1H(n) and Itgt1L(n), the calculation result of Expression 2 below is obtained as the arithmetic current value Itgt2L(n) or the arithmetic current value Itgt2H(n). Note that it is assumed that the arithmetic current value Itgt2L(n) is obtained by the target current waveform Imag·sinωt and the instantaneous value VAC becoming negative values in a case where the AC power output from the power supply circuit 2 is in the positive period and that the arithmetic current value Itgt2H(n) is obtained by the target current waveform Imag·sinωt and the instantaneous value VAC becoming positive values in a case where the AC power input to the power supply circuit 2 is in the negative period.

$$Itgt 2 ( n ) = Imag \cdot sin ω t + \frac{( VH - VAC )}{2 L} \cdot \frac{VAC}{VH} \cdot Ts + SA \cdot \frac{VAC}{VH} \qquad Expression 2$$

### <Derivation Example of Arithmetic Current Value Itgt1H(n)>

The clock time of the initial stage of the control cycle Ts (the initial stage of the ON period Ton) is defined as t, and the current value of the coil current IL at that time is defined as i(t). In addition, the current value of the coil current IL at the end of the ON period Ton is defined as i(Ton) (see FIG. 2B). Assuming that the average value of the coil current IL matches the average value of the target current waveform Imag·sinω, Expressions 3 and 4 below are established.

$$( i ( Ton ) + i ( t ) ) / 2 = Imag \cdot sin ω ( t + Ton / 2 ) \qquad Expression 3$$

$$i ( Ton ) = i ( t ) + ( VAC \times Ton ) / L \qquad Expression 4$$

Expression 5 below is obtained by substituting Expression 4 above into Expression 3 above and rearranging it.

$$i ( Ton ) = Imag \cdot sin ω ( t + Ton / 2 ) + ( VAC \times Ton ) / 2 L \qquad Expression 5$$

In addition, i(Ton) is expressed by the Expression 6 from the relationship between the arithmetic current value Itgt1H(n) and the amplitude SA.

$$i ( Ton ) = Itgt 1 H ( n ) - SA \cdot Ton / Ts \qquad Expression 6$$

The arithmetic current value Itgt1H(n) is expressed by Expression 7 below by substituting Expression 6 above into Expression 5 above and rearranging it.

$$Itgt 1 H ( n ) = Imag \cdot sin ω ( t + Ton / 2 ) + ( ( VAC \times Ton ) / 2 L ) + SA \cdot Ton / Ts \qquad Expression 7$$

Here, assuming that the period Ton is determined by the boosting ratio of the instantaneous value VAC and the DC voltage Vdc, Expression 8 below can be obtained, and Expression 9 below is obtained by solving Expression 8 below for the period Ton.

$$Ton / Ts = ( 1 - VAC / Vdc ) \qquad Expression 8$$

$$Ton = ( 1 - VAC / Vdc ) \cdot Ts \qquad Expression 9$$

Then, Expression 1 above is obtained by substituting Expression 9 above into Expression 7 above and ignoring a minute value (Ton/2).

Furthermore, the arithmetic current value Itgt2(n) can be derived by the same deriving method as the method of deriving the arithmetic current value Itgt1(n). Note that, as described above, it is only necessary for the arithmetic current value that is not to be compared with the coil current IL (Itgt1L(n) in the positive period in the first mode, Itgt1H(n) in the negative period in the first mode, Itgt2H(n) in the positive period in the second mode, and Itgt2L(n) in the negative period in the second mode) to be a value calculated by Expression 1, 2, or the like or a value obtained by shifting the target current waveform Imag·sinωt, or the like by a predetermined value such that the comparison with the coil current IL is not performed, depending on which of the positive period or the negative period the current period is.

### <Configuration Example of Peak Current Control Circuit PIC>

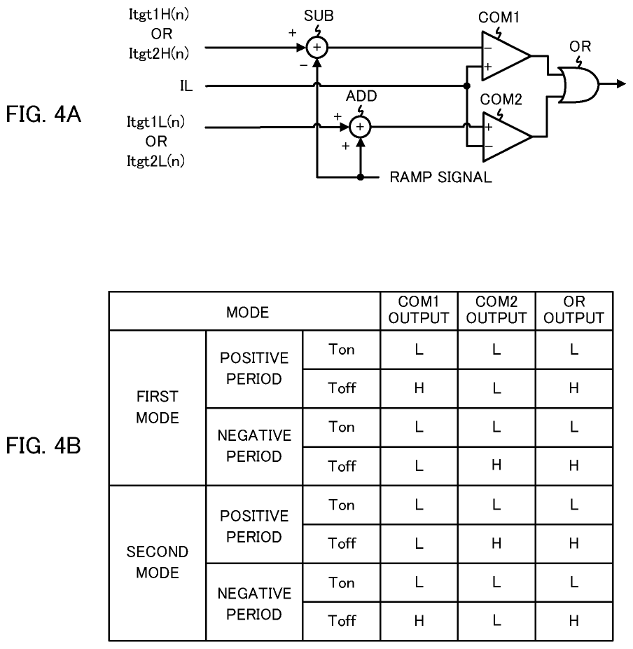

FIG. 4A is a diagram illustrating an example of the peak current control circuit PIC. FIG. 4B is a diagram illustrating an example of a truth value table corresponding to logic calculation of the peak current control circuit PIC illustrated in FIG. 4A.

The drive signal generation unit illustrated in FIG. 4A includes a subtractor SUB, an adder ADD, comparators COM1 and COM2, and an OR circuit OR.

The subtractor SUB subtracts the ramp signal from the arithmetic current value Itgt1H(n) and outputs a first threshold signal waveform as a result to a negative input terminal of the comparator COM1 in the first mode, and the subtractor SUB subtracts the ramp signal from the arithmetic current value Itgt2H(n) and outputs a second threshold signal waveform as a result to the negative input terminal of the comparator COM1 in the second mode.

The adder ADD adds the ramp signal to the arithmetic current value Itgt1L(n) and outputs the first threshold signal waveform as a result to a positive input terminal of the comparator COM2 in the first mode, and the adder ADD adds the ramp signal to the arithmetic current value Itgt2L(n) and outputs the second threshold signal waveform as a result to the positive input terminal of the comparator COM2 in the second mode.

The comparator COM1 outputs a low-level signal (L) to one input terminal of the OR circuit OR when the coil current IL input to the positive input terminal is smaller than the first threshold signal waveform or the second threshold signal waveform input to the negative input terminal, and the comparator COM1 outputs a high-level signal (H) to the one input terminal of the OR circuit OR when the coil current IL is greater than the first threshold signal waveform or the second threshold signal waveform.

The comparator COM2 outputs a high-level signal (H) to the other input terminal of the OR circuit OR when the coil current IL input to the negative input terminal is smaller than the first threshold signal waveform or the second threshold signal waveform input to the positive input terminal, and the comparator COM2 outputs a low-level signal (L) to the other input terminal of the OR circuit OR when the coil current IL is greater than the first threshold signal waveform or the second threshold signal waveform.

The OR circuit OR outputs a high-level signal (H) when at least one of a signal input to the one input terminal and a signal input to the other input terminal is at a high level, and the OR circuit OR outputs a low-level signal (L) when the input signals input to both the input terminals are at a low level.

Note that it is assumed that in the positive period, the signal output from the OR circuit OR is output as a drive signal S1′ to the drive circuit DRV and that an inverted signal of the drive signal S1′ is output as a drive signal S2′ to the drive circuit DRV. It is also assumed that in the negative period, the signal output from the OR circuit OR is output as the drive signal S2′ to the drive circuit DRV, and that the inverted signal of the drive signal S2′ is output as the drive signal S1′ to the drive circuit DRV. In addition, it is assumed that a circuit for holding a level of a signal such as a flip-flop is provided on the output side of each of the comparators COM1 and COM2, and that when the output signal of each of the comparators COM1 and COM2 is switched from the low level to the high level, the output signal of each of the comparators COM1 and COM2 is maintained at the high level until the next control cycle arrives.

In the first mode and in the positive period of the AC power input to the power supply circuit 2, for example, the drive signal S1′, which is the output signal of the OR circuit OR, is at the low level since the output signal of the comparator COM1 is at the low level while the output signal of the comparator COM2 is at the low level in the period Ton, and the drive signal S1′, which is the output signal of the OR circuit OR, is at the high level since the output signal of the comparator COM1 is at the high level and the output signal of the comparator COM2 is at the low level in the period Toff. Therefore, in the first mode and in the positive period of the AC power input to the power supply circuit 2, it is possible to “increase” the coil current IL by turning on the switching element SW2 in the period Ton and to “decrease” the coil current IL by turning off the switching element SW2 in the period Toff.

In the first mode and in the negative period of the AC power input to the power supply circuit 2, the drive signal S2′, which is the output signal of the OR circuit OR, is at the low level since the output signal of the comparator COM1 is at the low level while the output signal of the comparator COM2 is at the low level in the period Ton, and the drive signal S2′, which is the output signal of the OR circuit OR, is at the high level since the output signal of the comparator COM1 is at the low level and the output signal of the comparator COM2 is at the high level in the period Toff. Therefore, in the first mode and in the negative period of the AC power input to the power supply circuit 2, it is possible to “increase” the coil current IL by turning off the switching element SW2 in the period Ton and to “decrease” the coil current IL by turning on the switching element SW2 in the period Toff.

In the second mode and in the positive period of the AC power output from the power supply circuit 2, the drive signal S1′, which is the output signal of the OR circuit OR, is at the low level since the output signal of the comparator COM1 is at the low level while the output signal of the comparator COM2 is at the low level in the period Ton, and the drive signal S1′, which is the output signal of the OR circuit OR, is at the high level since the output signal of the comparator COM1 is at the low level and the output signal of the comparator COM2 is at the high level in the period Toff. Therefore, in the second mode and in the positive period of the AC power output from the power supply circuit 2, it is possible to “decrease” the coil current IL by turning on the switching element SW2 in the period Ton and to “increase” the coil current IL by turning off the switching element SW2 in the period Toff.

In the second mode and in the negative period of the AC power output from the power supply circuit 2, the drive signal S2′, which is the output signal of the OR circuit OR, is at the low level since the output signal of the comparator COM1 is at the low level while the output signal of the comparator COM2 is at the low level in the period Ton, and the drive signal S2′, which is the output signal of the OR circuit OR, is at the high level since the output signal of the comparator COM1 is at the high level and the output signal of the comparator COM2 is at the low level in the period Toff. Therefore, in the second mode and in the negative period of the AC power output from the power supply circuit 2, it is possible to “decrease” the coil current IL by turning off the switching element SW2 in the period Ton and to “increase” the coil current IL by turning on the switching element SW2 in the period Toff.

In other words, since the output signals of the OR circuit OR in FIG. 4B are the same in the first mode and the second mode, it is not necessary to switch the control target switching element in the first mode and the second mode. In this manner, it is possible to turn on and off the switching element SW2 in the positive period, to turn on and off the switching element SW1 in the negative period as the control target switching element in the first mode and the second mode, and to thereby eliminate the need for hardware for switching the control target switching element at the time of switching between the first mode and the second mode.

In addition, it is possible to convert the AC power into the DC power in the first mode and to convert the DC power into the AC power in the second mode only by changing the arithmetic current value input to the peak current control circuit PIC without changing the logic operation of the peak current control circuit PIC, and it is thus possible to avoid an increase in manufacturing cost accompanying a change in logic operation of the peak current control circuit PIC.

Note that the present invention is not limited to the embodiments described above, and various modifications or alterations can be made without departing from the gist of the present invention.

### <First Modification>

The above-mentioned embodiment is configured such that as the control target switching element to cause the coil current IL to follow the target current, operations of the switching element SW2 and operations of the switching element SW1 are controlled in the positive period and the negative period, respectively, in the other arm of the power supply circuit 2 in the first mode and the second mode. However, instead of this configuration, a configuration in which as the control target switching element, operations of the switching element SW1 and operations of the switching element SW2 may be controlled in the positive period and the negative period, respectively in the other arm may be adopted. In such a configuration, the arithmetic current values Itgt1H(n), Itgt1L(n), Itgt2H(n), and Itgt2L(n) are calculated such that the coil current IL becomes the target current in the first mode and the second mode.

Even with such a configuration, there is no need to switch the control target switching element at the time of switching between the first mode and the second mode, and it is possible to eliminate the need for hardware for selecting the control target switching element.

### <Second Modification>

The above-mentioned embodiment is configured such that in the positive period, a signal having the period until the coil current IL matches the threshold signal waveform from the initial stage of the control cycle Ts as the ON time of the switching element SW2 (the one switching element in the other arm) and having the period until the initial stage of the next control cycle Ts after the coil current IL matches the threshold signal waveform as the OFF time of the switching element SW2 is generated as a drive signal for the switching element SW2. Also, the configuration in which in the negative period, a signal having the period until the coil current IL matches the threshold signal waveform from the initial stage of the control cycle Ts as the ON time of the switching element SW1 (the other switching element in the other arm) and having the period until the initial stage of the next control cycle Ts after the coil current IL matches the threshold signal waveform as the OFF time of the switching element SW1 is generated as a drive signal for the switching element SW1 is adopted. However, the present invention is not limited to this configuration. A configuration in which in the positive period, a signal having the period until the coil current IL matches the threshold signal waveform from the initial stage of the control cycle Ts as the OFF time of the switching element SW2 and having the period until the initial stage of the next control cycle Ts after the coil current IL matches the threshold signal waveform as an ON time of the switching element SW2 is generated as a drive signal for the switching element SW2, and in the negative period, a signal having the period until the coil current IL matches the threshold signal waveform from the initial stage of the control cycle Ts as the OFF time of the switching element SW1 and having the period until the initial stage of the next control cycle Ts after the coil current IL matches the threshold signal waveform as the ON time of the switching element SW1 is generated as a drive signal for the switching element SW1 may be adopted. In such a configuration, the arithmetic current values Itgt1H(n), Itgt1L(n), Itgt2H(n), and Itgt2L(n) are calculated such that the coil current IL becomes the target current in the first mode and the second mode.

Even with such a configuration, it is possible to control operations of the control target switching element SW such that the coil current IL becomes the target current in the first mode and the second mode, there is thus no need to switch the control target switching element at the time of switching between the first mode and the second mode, and it is possible to eliminate the need for hardware for selecting the control target switching element.

### <Third Modification>

Although the threshold signal waveform to be compared with the coil current IL is generated using the arithmetic current waveform having a larger absolute value than the absolute value of the target current waveform Imag·sinωt in the first mode and using the arithmetic current waveform having a smaller absolute value than the absolute value of the target current waveform Imag·sinωt in the second mode in the above-mentioned embodiment, the present invention is not limited to the configuration. The threshold signal waveform may be generated using an arithmetic current waveform having a smaller absolute value than the absolute value of the target current waveform Imag·sinωt in the first mode and using an arithmetic current waveform having a larger absolute value than the absolute value of the target current waveform Imag·sinωt in the second mode.

Even with such a configuration, it is possible to control operations of the control target switching element SW such that the coil current IL becomes the target current in the first mode and the second mode, there is thus no need to switch the control target switching element at the time of switching between the first mode and the second mode, and it is possible to eliminate the need for hardware for selecting the control target switching element.

### <Fourth Modification>

Although the switching element SW1 and the switching element SW2 included in a single arm are defined as the switching elements in the other arm in the above-mentioned embodiment, a plurality of arms may be caused to perform interleaved operations as other arms. In this case, a plurality of upper arm switching elements in the plurality of arms may be regarded as switching elements SW1 while a plurality of lower arm switching elements may be regarded as switching elements SW2. Note that the one arm may also include a plurality of arms.

### <Fifth Modification>

Although the DC load Ldc and the DC power supply Pdc are connected directly to the other end, which is the DC side, of the power supply circuit 2 in the above-mentioned embodiment, the DC load Ldc and the DC power supply Pdc may be connected thereto via a DCDC converter.

What is claimed is:

1. A bidirectional power supply device comprising:
a power supply circuit including a coil and a switching element connected in an H bridge connection by a plurality of arms; and
a control unit that controls operations of an upper arm switching element and a lower arm switching element in one arm of the power supply circuit in accordance with a polarity of an alternating current at one end and controls operations of the upper arm switching element and the lower arm switching element in the other arm of the power supply circuit so that a coil current flowing through the coil becomes a target current in a first mode in which an AC power supply is connected to one end of the power supply circuit and a DC load is connected to the other end of the power supply circuit or a second mode in which an AC load is connected to the one end of the power supply circuit and a DC power supply is connected to the other end of the power supply circuit,
wherein the control unit is configured such that, as the other arm drive signal for driving the upper arm switching element and the lower arm switching element in the other arm,
the control unit compares a first threshold signal waveform obtained by adding a ramp signal in a direction approaching zero to an arithmetic current value in an initial stage of each control cycle of the switching elements with the coil current using an arithmetic current waveform having a larger absolute value than an absolute value of a target current waveform and generates the other arm drive signal that switches between a period until the coil current matches the first threshold signal waveform from the initial stage of the control cycle and a period until the initial stage of the next control cycle after the coil current matches the first threshold signal waveform, in one of the first mode and the second mode, and
the control unit compares a second threshold signal waveform obtained by adding the ramp signal in a direction separated from zero to the arithmetic current value in the initial stage of each control cycle with the coil current using an arithmetic current waveform having a smaller absolute value than the absolute value of the target current waveform and generates the other arm drive signal that switches between a period until the coil current matches the second threshold signal waveform from the initial stage of the control cycle and a period until the initial stage of the next control cycle after the coil current matches the second threshold signal waveform, in the other one of the first mode and the second mode.

2. The bidirectional power supply device according to claim 1,
wherein the control unit is configured such that
the control unit generates a first signal having a period until the coil current matches the first threshold signal waveform from the initial stage of the control cycle as an ON period and having a period until the initial stage of the next control cycle after the coil current matches the first threshold signal waveform as an OFF period in the first mode,
the control unit generates a second signal having a period until the coil current matches the second threshold signal waveform from the initial stage of the control cycle as an ON period and having a period until the initial stage of the next control cycle after the coil current matches the second threshold signal waveform as an OFF period in the second mode,
the control unit uses the first signal and the second signal as drive signals for the one switching elements in the other arm and uses inverted signals of the first signal and the second signal as drive signals for the other switching element in the other arm in a positive period of a polarity of the alternating current, and
the control unit uses the first signal and the second signal as drive signals for the other switching element in the other arm and uses the inverted signals of the first signal and the second signal as drive signals for the one switching element in the other arm in a negative period of the polarity of the alternating current.

3. The bidirectional power supply device according to claim 1,
wherein when Imag denotes an amplitude of the target current waveform, @ denotes an angular frequency of the target current waveform, t denotes a current clock time, Vdc is a DC voltage output from the power supply circuit or a DC voltage input to the power supply circuit, VAC denotes an instantaneous value of an AC voltage input to the power supply circuit or an AC voltage output from the power supply circuit, L denotes an inductance value of the coil, SA denotes an amplitude of the ramp signal, and Ts denotes the control cycle, the control unit regards Itgt1(n), which is a calculation result of Expression 1 below, as the arithmetic current value to be used in the first mode and regards Itgt2(n), which is a calculation result of Expression 2 below, as the arithmetic current value to be used in the second mode.
$$Itgt 1 ( n ) = Imag \cdot sin ω t + \frac{VAC}{2 L} ( 1 - \frac{VAC}{VH} ) \cdot Ts + SA \cdot ( 1 - \frac{VAC}{VH} ) \qquad Expression 1$$
$$Itgt 2 ( n ) = Imag \cdot sin ω t + \frac{( VH - VAC )}{2 L} \cdot \frac{VAC}{VH} \cdot Ts + SA \cdot \frac{VAC}{VH} \qquad Expression 2$$
